(19) United States
(12) Patent Application Publication
(10) Pub. No.: US 2020/0156402 A1
(43) Pub. Date: May 21, 2020

(54) PROTECTIVE DEVICE FOR PROCESSING MACHINE AND PROCESSING MACHINE

(71) Applicant: DGSHAPE CORPORATION, Hamamatsu-shi (JP)

(72) Inventor: Akari SAKURAGI, Hamamatsu-shi (JP)

(21) Appl. No.: 16/686,777

(22) Filed: Nov. 18, 2019

(30) Foreign Application Priority Data
Nov. 19, 2018 (JP) 2018-216508

(51) Int. Cl. B44B 3/06

(52) U.S. Cl. CPC B44B 3/06; B44B 2700/12

(57) ABSTRACT

A protective device for a processing machine is provided. The protective device includes one end portion including an opening portion, another end portion configured to be detachably attached to a tip end tool holding portion of processing machine, a main body portion extending in a predetermined direction from the other end portion to the one end portion and including a hollow portion communicating with the opening portion, and a spherical member rollably supported by the one end portion and protruding in the predetermined direction from an end surface of the one end portion.

### CROSS REFERENCE TO RELATED APPLICATIONS

This application claims priority to Japanese Patent Application No. 2018-216508 filed on Nov. 19, 2018, the entire contents of which are incorporated herein by reference.

### BACKGROUND OF THE INVENTION

### 1. Field of the Invention

The present invention relates to a protective device for a processing machine and a processing machine.

### 2. Description of Related Art

A related art protective device for a tip end tool of a processing machine is attached to a holding portion of a tip end tool and surrounds a periphery of the tip end tool (see, for example, JP2009-012295A).

During the processing operation of the processing device, the protective device slides on a surface of a workpiece. Therefore, a scratch or the like may occur mainly at a part of the workpiece where the protective device is slid, and the workpiece may be damaged.

### SUMMARY

One or more embodiments of the present invention provide a protective device for a processing machine or a processing machine which can reduce risk of damage to a workpiece.

One or more embodiments of the present invention provide a protective device for a processing machine, the protective device includes one end portion having an opening portion, another end portion which is configured to be detachably attached to a tip end tool holding portion of the processing machine, a main body portion extending in a predetermined direction from the other end portion to the one end portion and includes a hollow portion communicating with the opening portion, and a spherical member rollably supported by the one end portion and protrudes in the predetermined direction from an end surface of the one end portion.

One or more embodiments of the present invention provide a processing machine including a motor, a tip end tool configured to be rotated by the motor, a holding portion which is configured to hold the tip end tool rotatably, and a protective device. The protective device includes one end portion, another end portion, a main body portion, and a spherical member. The one end portion includes an opening portion. The other end portion is configured to be attached to and detached from the holding portion. The main body portion extends in a predetermined direction from the other end portion to the one end portion and includes a hollow portion communicating with the opening portion. The spherical member is rollably supported by the one end portion and protrudes in the predetermined direction from an end surface of the one end portion in the predetermined direction.

According to one or more embodiments, a protective device for a processing machine or a processing machine can reduce the risk of damage to a workpiece.

### BRIEF DESCRIPTION OF THE DRAWINGS

FIG. 1 is a perspective view of an engraving machine according to a first embodiment. In order to facilitate understanding, an illustration of a guard holder and a nose guard is omitted.

FIG. 2 is a block diagram of the engraving machine according to the first embodiment.

FIG. 3A is a perspective view of the nose guard according to the first embodiment as viewed from a lower side of the nose guard. FIG. 3B is a perspective view of the nose guard according to the first embodiment as viewed from an upper side of the nose guard.

FIG. 4A is a longitudinal sectional view of the nose guard according to the first embodiment. FIG. 4B is a cross-sectional view of the nose guard according to the first embodiment.

FIG. 5 is a cross-sectional view illustrating a state where the nose guard according to the first embodiment is attached to the guard holder. In order to facilitate understanding, an outline of a tip end tool is illustrated as a dotted line.

FIG. 6A is a perspective view of a nose guard according to a second embodiment as viewed from a lower side of the nose guard. FIG. 6B is a perspective view of the nose guard according to the second embodiment as viewed from an upper side of the nose guard.

FIG. 7A is a longitudinal sectional view of the nose guard according to the second embodiment. FIG. 7B is a cross-sectional view of the nose guard according to the second embodiment.

FIG. 8 is a side view illustrating a state where the nose guard according to a third embodiment is attached to the guard holder.

FIG. 9A is a perspective view of the nose guard according to the third embodiment as viewed from a lower side of the nose guard. FIG. 9B is a cross-sectional view at an upper side of a partition wall. FIG. 9C is a cross-sectional view at a lower side of the partition wall.

FIG. 10A is a perspective view of a nose guard according to a fourth embodiment as viewed from a lower side of the nose guard. FIG. 10B is a cross-sectional view of the nose guard according to the fourth embodiment. FIG. 10C is a perspective view of one end portion of the nose guard according to the fourth embodiment.

FIG. 11A is a side view of a nose guard according to a fifth embodiment. FIG. 11B is a cross-sectional view taken along a line B-B in FIG. 11A.

FIGS. 12A and 12B are side views illustrating a state where the nose guard according to the fifth embodiment is attached to the guard holder. FIG. 12A illustrates a state where a dust collection adapter is further attached. FIG. 12B illustrates a state where the dust collection adapter is removed.

### DETAILED DESCRIPTION

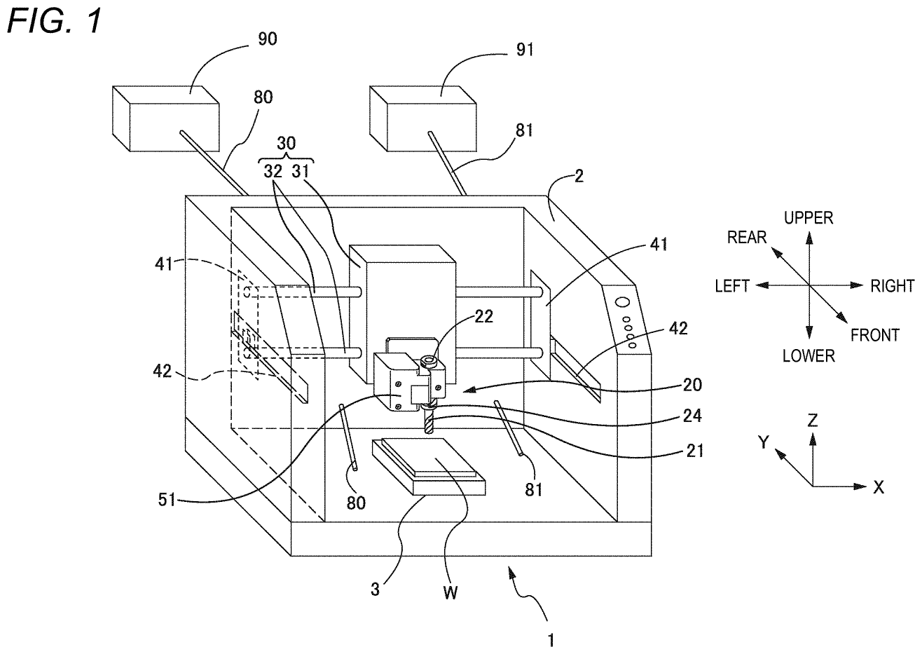

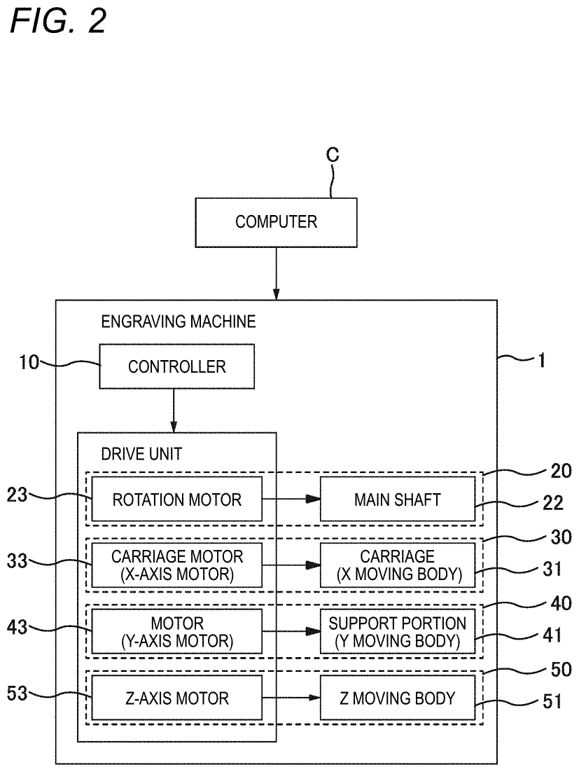

FIG. 1 is a schematic explanatory view of an engraving machine 1 according to an embodiment of the present invention. The engraving machine 1 is an example of a processing machine. FIG. 2 is a block diagram of the engraving machine 1. The engraving machine 1 includes a substantially rectangular housing 2. The housing 2 is provided with a table portion 3 which is configured to mount and fix a workpiece W horizontally.

The engraving machine 1 is configured to process a surface of a workpiece W using a tip end tool 21 to engrave a character, an image, or the like. The workpiece W is a three-dimensional member made of a material which is metal, acrylic, or the like. Main materials include materials made of metal, wood, ABS resin, polyacetal, acrylic, polycarbonate, and the like.

The engraving machine 1 includes a controller 10, a rotation unit 20, a carriage unit 30, a Y-axis drive mechanism 40, and an upper-lower movement unit 50.

In the engraving machine 1, a dust collection device 90 and an exhaust device 91 can be installed outside the housing 2. At a time of installation, the dust collection device 90 and the exhaust device 91 are connected to a nose guard 60 via tubes 80, 81. Each of the tubes 80, 81 is a hollow tubular member made of vinyl or the like, and an end portion of each of the tubes 80, 81 can be disposed inside the housing 2 through a rear portion of the housing 2.

In the following description, each direction is defined as illustrated in FIG. 1. That is, a direction parallel to a rotation axis of the tip end tool 21 (for example, the end mill) is defined as an “upper-lower direction”. A side of the workpiece W when viewed from the tip end tool 21 is defined as “lower”, and an opposite side is defined as “upper”. The upper-lower direction may be referred to as a “Z-axis direction”. A moving direction of the carriage unit 30 is defined as “left-right direction”. A right side is defined as “right” and a left side is defined as “left” when viewed from an operator. The left-right direction may be referred to as an “X-axis direction”. A direction perpendicular to the upper-lower direction and the left-right direction is defined as a “front-rear direction”. An operator side, when viewed from the engraving machine 1, is defined as “front”, and an opposite side is defined as “rear”. The front-rear direction may be referred to as a “Y-axis direction”. Directions of components of the engraving machine 1 are also determined based on a state of being attached to the engraving machine 1. The upper-lower direction or the Z-axis direction is an example of a predetermined direction.

The controller 10 is a control unit which is configured to control the engraving machine 1. The controller 10 controls a drive unit (a rotation motor 23, a carriage motor 33, a motor 43, and a Z-axis motor 53 described later) of the engraving machine 1 based on processing instruction data from a computer C. The controller 10 is the control unit which is configured to control the engraving machine 1.

The rotation unit 20 is configured to rotate the tip end tool 21. The rotation unit 20 is held by the carriage unit 30 and the upper-lower movement unit 50. The rotation unit 20 includes a tip end tool 21, a main shaft 22, a rotation motor 23, and a tip end tool holding unit 24.

The tip end tool 21 is configured to process the workpiece W by being rotated by the rotation shaft and may be replaced depending on an intended use. The tip end tool 21 includes a blade portion and a base end portion. A blade is formed on the blade portion. The blade portion is formed by forming the blade on a lower end and a side surface of the columnar tip end tool 21. The blade is not formed on the base end portion. The base end portion is located on an upper side of the blade portion and is configured to be detachably attached to a collet (not illustrated).

The main shaft 22 is configured to rotate the tip end tool 21. The spindle 22 may also be referred to as a spindle, a shaft, or the like. The main shaft 22 extends in the upper-lower direction. The tip end tool 21 is detachably mounted on a lower end portion of the main shaft 22 via the collet (not illustrated). The rotation motor 23 is a power source which is configured to rotate the main shaft 22 (and the tip end tool 21). Here, a brushless DC motor is used as the rotation motor 23.

The tip end tool holding portion 24 is a substantially cylindrical member extending in the upper-lower direction and supports the main shaft 22 in the tip end tool holding portion 24 rotatably. As illustrated in FIG. 1, the tip end tool 21 held by the main shaft 22 extends downward from a lower end portion of the tip end tool holding portion 24. In other words, the tip end tool holding portion 24 is configured to rotatably hold the tip end tool 21 via the main shaft 22.

The carriage unit 30 is configured to move the tip end tool 21 and the workpiece W relatively in the X-axis direction. Here, the carriage unit 30 realizes the relative movement of the tip end tool 21 and the workpiece W in the X-axis direction by moving the tip end tool 21 in the X-axis direction. The carriage unit 30 includes a carriage 31, an X guide 32, and a carriage motor 33. The carriage 31 is an X moving body which is configured to move in the X-axis direction. The X guide 32 is two shaft-shaped members extending in the X-axis direction and is configured to guide the carriage 31 in the X-axis direction.

The carriage motor 33 is a power source which is configured to move the carriage 31 in the X-axis direction. The rotation unit 20 is supported by the carriage 31 via the upper-lower movement unit 50. When the carriage 31 moves in the X-axis direction, the rotation unit 20 also moves in the X-axis direction, whereby the tip end tool 21 also moves in the X-axis direction.

The carriage unit 30 is supported by the Y-axis drive mechanism 40. The Y-axis drive mechanism 40 is configured to move the carriage unit 30 in the Y-axis direction and includes two support portions 41, two Y guides 42, and a motor 43. The support portion 41 is disposed at each of left and right end portions of the X guide 32 and is configured to support the X guide 32. The Y guides 42 are shaft-shaped members disposed at each of left and right of the carriage unit 30 and are supported by the housing 2 so as to extend in the Y-axis direction. The Y guide 42 supports the support portion 41 slidably. The motor 43 is a power source which is configured to move the support portion 41 along the Y guide 42 in the Y-axis direction.

The engraving machine 1 includes the upper-lower movement unit 50 which is configured to move the tip end tool 21 and the workpiece W relatively in the upper-lower direction (the Z-axis direction). Here, the upper-lower movement unit 50 is configured to be movable relative to the carriage 31. Specifically, the upper-lower movement unit 50 includes a Z moving body 51 which is configured to move in the Z-axis direction relative to the carriage 31, and a Z-axis motor 53 which is a driving source configured to move the Z moving body 51 in the Z-axis direction. However, the upper-lower movement unit 50 may be configured to move the table portion 3 and the workpiece W in the Z-axis direction. The engraving machine 1 includes the carriage unit 30, the Y-axis drive mechanism 40, and the upper-lower movement unit 50, whereby the tip end tool 21 can be moved relative to the workpiece W in three dimensions (in the X-axis direction, the Y-axis direction, and the Z-axis direction).

The computer C is connected to the engraving machine 1 communicably. The computer C generates processing instruction data for controlling the engraving machine 1 and outputs the processing instruction data to the engraving machine 1. The computer C is, for example, a general-purpose personal computer, and includes a CPU, a memory, a storage device, a communication unit, and the like. The CPU is configured to execute various processes to be described later by reading a program stored in the storage device to the memory and executing the program. Programs and various types of data are stored in the storage device. The communication unit is a communication module (for example, a USB module) which is configured to connect to the engraving machine 1.

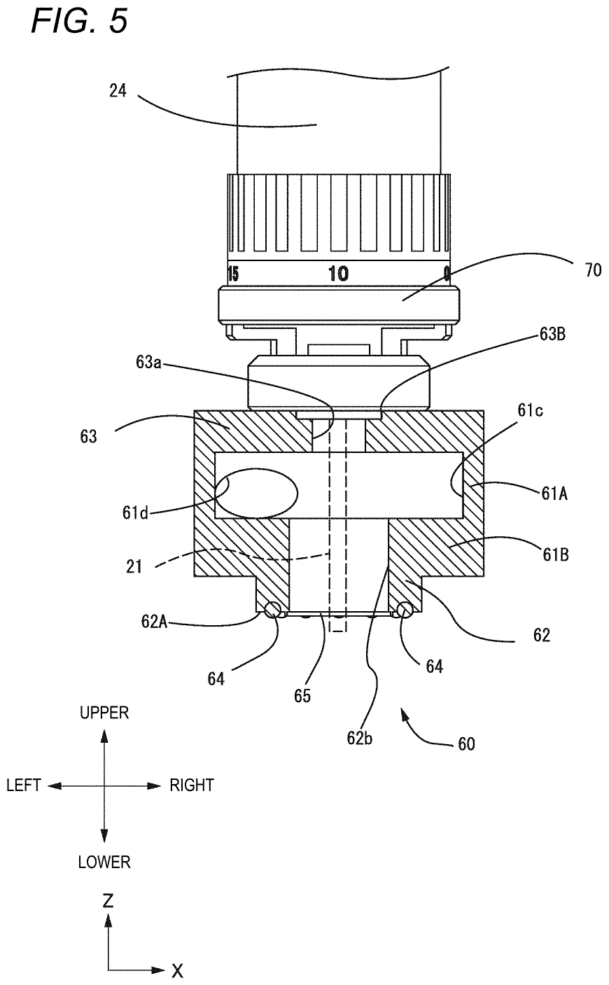

The engraving machine 1 further includes a nose guard 60 and a guard holder 70. When the processing operation is performed, the nose guard 60 and the guard holder 70 can be used by being attached to the tip end tool holding portion 24. Hereinafter, the nose guard 60 and the guard holder 70 will be described. As illustrated in FIG. 5, the guard holder 70 is screwed to and detachably attached to the tip end tool holding portion 24. The guard holder 70 has a substantially cylindrical shape extending in the Z-axis direction in the attached state. An inner peripheral surface of the guard holder 70 is threaded and is screwed to an outer peripheral surface of the tip end tool holding portion 24. The nose guard 60 can be attached to a lower end portion of the guard holder 70. An upper-lower position of the guard holder 70 with respect to the tip end tool holding portion 24 can be adjusted by rotating the guard holder 70 to the left and right. Accordingly, a desired engraving depth can be set by adjusting the upper-lower position of the nose guard 60 and a protrusion amount of the tip end tool 21 from a lower end of the nose guard 60.

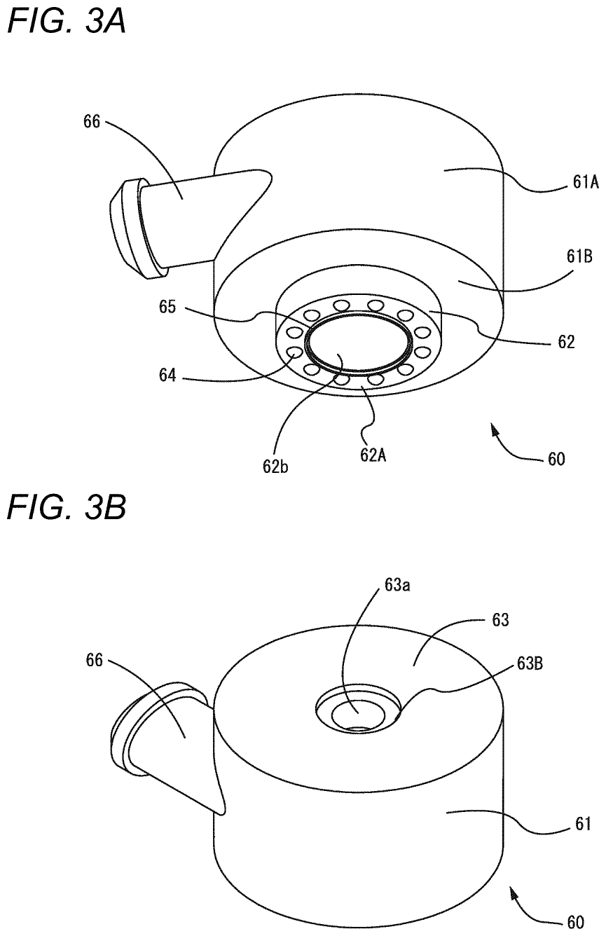

As illustrated in FIGS. 3A to 5, the nose guard 60 is detachably attached to the guard holder 70. In other words, the nose guard 60 is detachably attached to the tip end tool holding portion 24 via the guard holder 70. Specifically, in the present embodiment, the nose guard 60 is attached by engaging with the lower end portion of the guard holder 70 and is removable by disengaging. Various methods, which are screwing, fitting, press fitting, and the like, may be used as a method of attaching the nose guard 60. The nose guard 60 is not necessarily required to be detachable from the guard holder 70 and may be a unit integral with the guard holder 70.

The nose guard 60 includes a main body portion 61, one end portion 62, the other end portion 63, a ball member 64, a partitioning member 65, and an air suction portion 66. The ball member 64 is an example of a spherical member. As illustrated in FIG. 5, the nose guard 60 is disposed around the tip end tool 21, partitions a periphery of a processing site which is a contact point between the tip end tool 21 and the workpiece W, and blocks the periphery of the processing site from outside. A lower end portion of the nose guard 60 has a function of adjusting the protrusion amount of the tip end tool 21 and adjusting the engraving depth.

The main body portion 61 is a hollow member extending in the Z-axis direction from the other end portion 63 to the one end portion 62 and includes a side wall 61A and a bottom wall 61B. The side wall 61A is a hollow and substantially cylindrical member extending in the Z-axis direction. The side wall 61A is formed with a communication hole 61d having a substantially oval shape in a side view. The communication hole 61d communicates with the air suction portion 66 and the outside. The bottom wall 61B is a plate-shaped member formed in a substantially annular shape such that an outer end portion of the bottom wall 61B is connected to a lower end portion of the side wall 61A. The bottom wall 61B extends in a substantially horizontal direction and is connected to the one end portion 62 at a central part of the bottom wall 61B. A hollow portion 61c, which is defined by the side wall 61A and the bottom wall 61B, is formed inside the main body portion 61. The hollow portion 61c communicates with the air suction portion 66 and the outside through the communication hole 61d. An upper part of the hollow portion 61c is defined by the other end portion 63.

The one end portion 62 is a hollow and substantially cylindrical member extending in the Z-axis direction and includes an opening portion 62b inside the one end portion 62. The opening portion 62b is defined by an inner peripheral surface of the one end portion 62. The opening portion 62b communicates with the hollow portion 61c at an upper part of the opening portion 62b and communicates with the outside at a lower part of the opening portion 62b. An upper end portion of the one end portion 62 is connected to the bottom wall 61B. A lower end portion of the one end portion 62 is formed with a lower end surface 62A having an annular shape.

The other end portion 63 has a substantial disk shape in a top view and is connected to an upper end portion of the side wall 61A. An opening portion 63a having a substantially circular shape in the top view is formed at a central part of the other end portion 63. The opening portion 63a is a hole for passing the tip end tool 21 in the Z-axis direction and communicates with the hollow portion 61c. An engagement portion 63B having a substantially circular shape in the top view is formed at the central part of the other end portion 63. An inner peripheral portion of the engagement portion 63B is engageable with the lower end portion of the guard holder 70. The nose guard 60 is detachably attached to the guard holder 70 by the engaging portion 63B engaging with the guard holder 70. As described above, various methods, which are screwing, fitting, press fitting, and the like, may be used as a method of engaging or attaching the engagement portion 63B to the guard holder 70.

The ball member 64 is a substantially spherical member, and a plurality of ball members 64 are provided at the lower end portion of the one end portion 62. The ball members 64 are disposed at equal intervals in an annular shape in a bottom view. An upper end portion of each of the ball members 64 is rollably supported by the one end portion 62. Each of the ball members 64 is supported so as to be capable of rolling in any direction of the left, the right, the front, and the rear relative to the one end portion 62. A lower end portion of each of the ball members 64 protrudes downward from the lower end surface 62A, that is, in the Z-axis direction.

The partitioning member 65 is fixed to a lower part of the one end portion 62 and extends downward from the lower end surface 62A. The partitioning member 65 is disposed closer to the opening portion 62b than the ball member 64 in the bottom view and is disposed in an annular shape along an extending direction of the inner peripheral surface of the one end portion 62. A lower end portion of the partition member 65 is formed to be flush with or lower than the lower end portion of the ball member 64. The partition member 65 is formed of an elastic member softer than the workpiece W, which is rubber, mohair, or the like, at least at the lower end portion of the partition member 65. The partition member 65 has a function of partitioning the opening portion 62b and the periphery of the processing site and blocking the opening portion 62b and the periphery of the processing site from the outside by coming into contact with the workpiece W at a time of processing operation.

The air suction portion 66 is a hollow cylindrical member and is provided so as to protrude in a horizontal direction from the side wall 61A. An air suction hole 66a having a substantially oval shape in a cross-sectional view is formed inside the air suction portion 66. The air suction hole 66a communicates with the communication hole 61d and the hollow portion 61c. The air suction hole 66a communicates with the outside at an outer end portion of the air suction portion 66. A tube 80 can be attached to the outer end portion of the air suction portion 66. Therefore, the air suction portion 66 can be connected to a dust collection device 90 through the tube 80.

In the first embodiment, the main body portion 61, the one end portion 62, the other end portion 63, and the air suction portion 66 are formed integrally. The main body portion 61, the one end portion 62, the other end portion 63, and the air suction portion 66 may be formed by a plurality of members.

The dust collection device 90 illustrated in FIG. 1 has an air suction function and a dust collection function. Specifically, the dust collection device 90 can move a cutting chip from inside of the nose guard 60 by suctioning air through the tube 80 and the air suction portion 66 and can store the cutting chip inside the dust collection device 90.

Hereinafter, the processing operation by the engraving machine 1 to which the nose guard 60 is mounted will be described. First, a user places and fixes the workpiece W on the table portion 3. Next, the user uses the computer C to output the processing instruction data for controlling the engraving machine 1 to the engraving machine 1.

Upon receiving the processing instruction data, the engraving machine 1 starts the processing operation based on the data. The engraving machine 1 engraves an image, a character, and the like by causing the tip end portion of the tip end tool 21 rotating at high speed to abut against the workpiece W and scanning the upper-lower movement unit 50 and the tip end tool 21 in three dimensions.

In the time of the processing operation, the nose guard 60 is brought into contact with the workpiece W to adjust the upper-lower position of the tip end tool 21 with respect to the workpiece W to cause the engraving depth to be appropriate. At this time, the ball member 64 rolls while being in contact with the workpiece W and follows the scanning of the tip end tool 21. The ball member 64 does not slide but rolls relative to the workpiece W. Therefore, the workpiece W is prevented from being scratched.

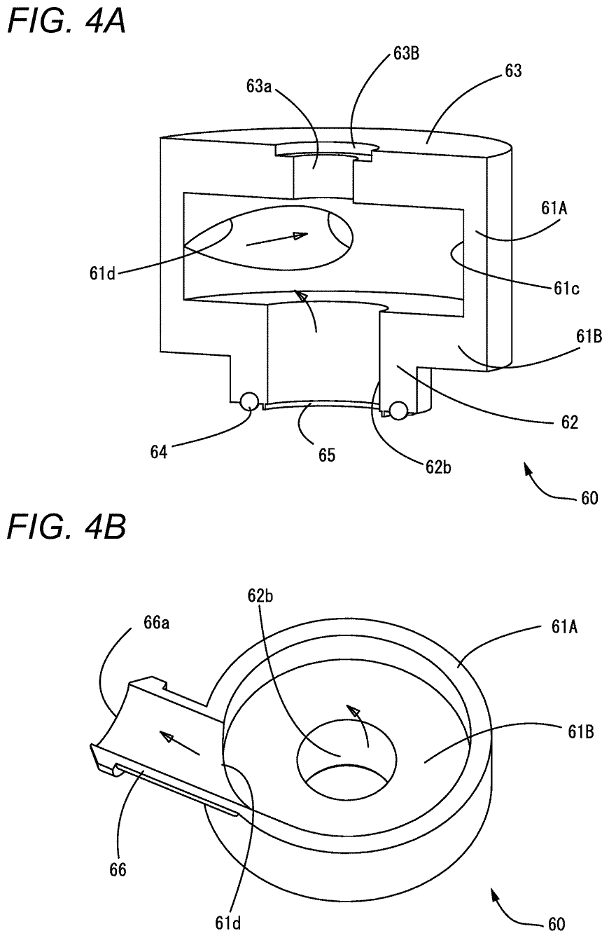

In the processing operation, the cutting chip is generated due to scraping of the workpiece W. The cutting chip is collected by the dust collection device 90 provided outside the nose guard 60. Specifically, the dust collection device 90 suctions air in parallel with the processing operation and moves air from inside of the nose guard 60 through the tube 80. With the movement of air, as indicated by white arrows in FIGS. 4A and 4B, the cutting chip sequentially passes through the opening portion 62b, the hollow portion 61c, the communication hole 61d, and the air suction hole 66a, and is finally collected to the dust collection device 90.

A part of the cutting chip is to be scattered radially outward of the tip end tool 21 as the tip end tool 21 rotates. At this time, the partitioning member 65 partitions a periphery of the opening portion 62b, thereby preventing the cutting chip from being scattered outward. Accordingly, the cutting chip is collected efficiently. The partitioning member 65 also prevents the cutting chip from entering between the ball member 64 and the workpiece W. Therefore, the workpiece W is prevented from being damaged.

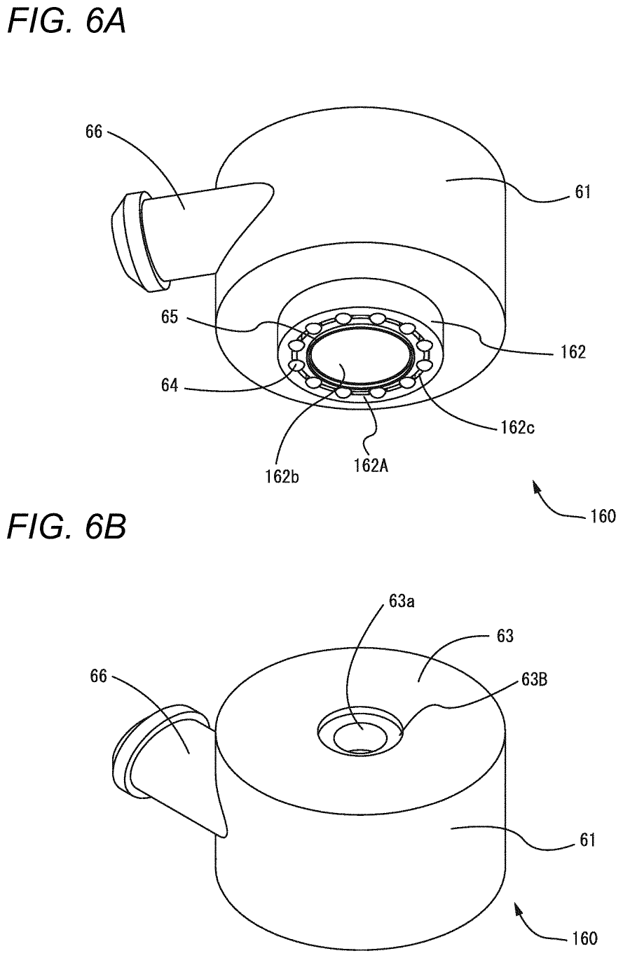

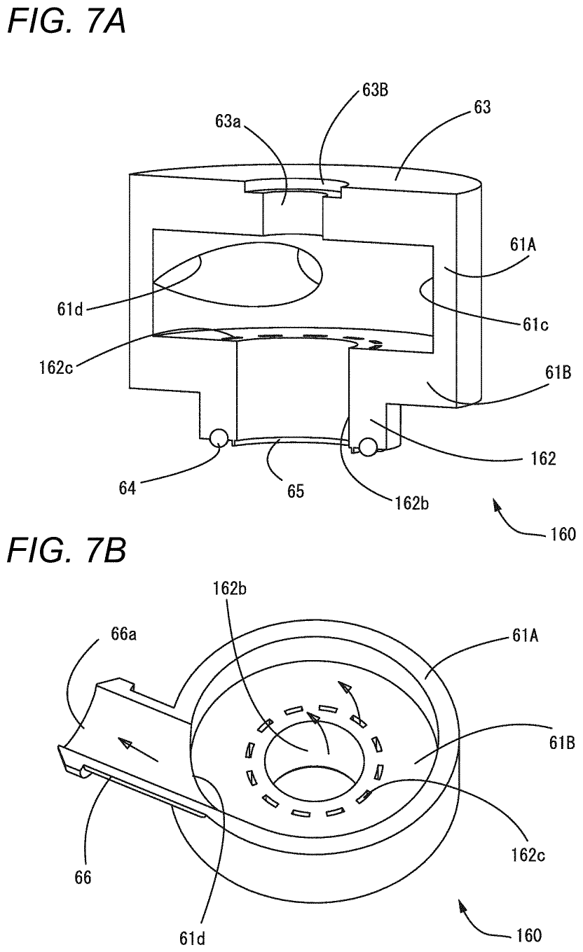

A nose guard 160 according to a second embodiment of the present invention will be described with reference to FIGS. 6A to 7B. The second embodiment will be described by adding 100 to reference numerals of the members corresponding to the first embodiment. The same members as those in the first embodiment are denoted by the same reference numerals, and the description of the same members is omitted.

The nose guard 160 includes a main body portion 61, one end portion 162, the other end portion 63, the ball member 64, the partitioning member 65, and the air suction portion 66. The members other than the one end portion 162 are substantially the same as those according to the first embodiment. That is, the main body 61, the other end portion 63, the ball member 64, the partitioning member 65, and the air suction portion 66 are substantially the same as those according to the first embodiment.

The one end portion 162 is a hollow and substantially cylindrical member extending in the Z-axis direction and includes an opening portion 162b inside the one end portion 162. The opening portion 162b is defined by an inner peripheral surface of the one end portion 162. The opening portion 162b communicates with the hollow portion 61c at an upper part of the opening portion 162b and communicates with the outside at a lower part of the opening portion 162b. An upper end portion of the one end portion 162 is connected to the bottom wall 61B. A lower end portion of the one end portion 162 is formed with a lower end surface 162A having an annular shape.

Ventilation holes 162c are formed at a plurality of places of the one end portion 162. Each of the ventilation holes 162c has a substantially rectangular shape in the bottom view and is formed so as to penetrate the one end portion 162 in the Z-axis direction. The ventilation holes 162c are positioned between the ball members 64 and are disposed in an annular shape in the bottom view. The ventilation hole 162c is located outward of the partitioning member 65 disposed in an annular shape in the bottom view. The ventilation hole 162c communicates with the hollow portion 61c at an upper part of the one end portion 162 and communicates with the outside at a lower part of the one end portion 162. The one end portion 162 supports the plurality of ball members 64 rollably. Each of the ball members 64 is supported so as to be capable of rolling in any direction of the left, the right, the front, and the rear relative to the one end portion 162. The lower end portion of each of the ball members 64 protrudes downward from the lower end surface 162A. Similarly to the first embodiment, the partitioning member 65 is fixed to a lower part of the one end portion 162 and extends downward from the lower end surface 162A, that is, in the Z-axis direction.

Similarly to the first embodiment, the cutting chip is collected from the opening portion 162b during the processing operation. The cutting chip is collected not only from the opening portion 162b but also from the ventilation hole 162c. Specifically, as indicated by white arrows in FIG. 7B, the cutting chip sequentially passes through the opening portion 162b, the ventilation hole 162c, the hollow portion 61c, the communication hole 61d, and the air suction hole 66a and is finally collected to the dust collection device 90.

The partitioning member 65 partitions a periphery of the opening portion 162b, thereby preventing the cutting chip from being scattered outward. Even if the cutting chip is scattered beyond the partition member 65, the cutting chip is collected efficiently from the ventilation hole 162c, so that the cutting chip is prevented from entering between the ball member 64 and the workpiece W. Therefore, the workpiece W is prevented from being damaged.

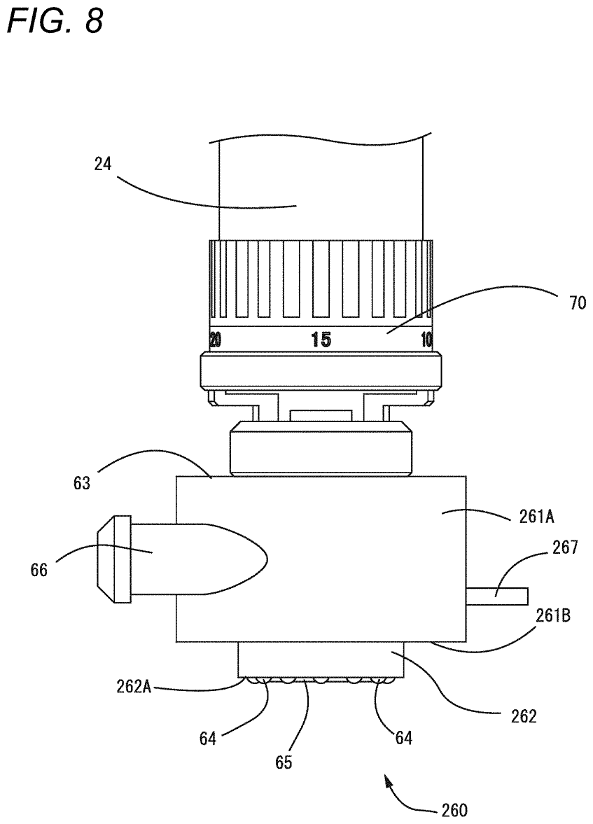

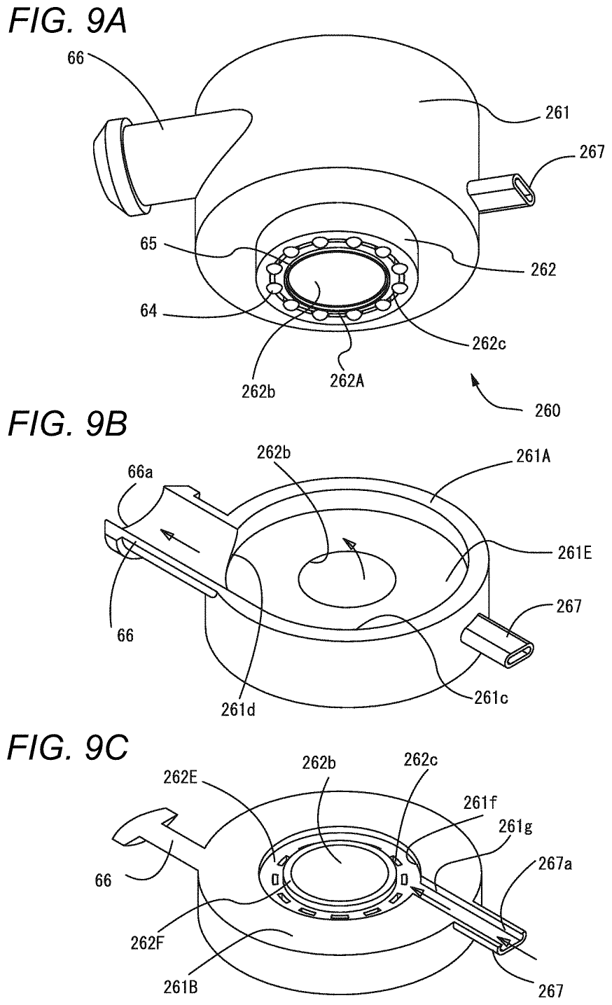

A nose guard 260 according to a third embodiment of the present invention will be described with reference to FIGS. 8 to 9C. The third embodiment will be described by adding 200 to the reference numerals of the members corresponding to the first embodiment. The same members as those in the first embodiment are denoted by the same reference numerals, and the description of the same members is omitted.

The nose guard 260 includes a main body portion 261, one end portion 262, the other end portion 63, the ball member 64, the partitioning member 65, the air suction portion 66, and an exhaust portion 267. The other end portion 63, the ball member 64, the partitioning member 65, and the air suction portion 66 are the same as those according to the first embodiment.

The main body portion 261 is a hollow member extending in the Z-axis direction from the other end portion 63 to the one end portion 262 and includes a side wall 261A, a bottom wall 261B, and a partition wall 261E. The side wall 261A is a hollow and substantially cylindrical member extending in the Z-axis direction. The side wall 261A is formed with a communication hole 261d and a communication hole 261g which have a substantially oval shape in the side view. The communication hole 261d communicates with the outside through the air suction portion 66. The communication hole 261g is formed below the communication hole 261d and communicates with the outside through the exhaust portion 267. The bottom wall 261B is a plate-shaped member formed in a substantially annular shape such that an outer end portion of the bottom wall 261B is connected to a lower end portion of the side wall 261A. The bottom wall 261B extends in the substantially horizontal direction and is connected to the one end portion 262 at a central part of the bottom wall 261B.

The partition wall 261E is provided between the communication hole 261d and the bottom wall 261B in the Z-axis direction. The partition wall 261E is a plate-shaped member which is formed in a substantially annular shape and which extends in the horizontal direction. An outer end portion of the partition wall 261E is connected to the side wall 261A, and a central part of the partition wall 261E is connected to an upper end portion of the one end portion 262.

A first hollow portion 261c, which is defined by the side wall 261A and an upper surface of the partition wall 261E, is formed inside the main body portion 261. The first hollow portion 261c communicates with the air suction hole 66a and the outside through the communication hole 261d. An upper part of the first hollow portion 261c is defined by the other end portion 63.

A second hollow portion 261f, which is defined by the side wall 261A and a lower surface of the partition wall 261E, is formed in the main body portion 261. In other words, the partition wall 261E partitions a hollow portion of the main body portion 261 into the first hollow portion 261c and the second hollow portion 261f. The second hollow portion 261f is formed in a substantially annular shape. A lower part and a central part of the second hollow portion 261f are defined by the one end portion 262. The second hollow portion 261f communicates with the communication hole 261g and the exhaust portion 267.

The one end portion 262 is a hollow and substantially cylindrical member extending in the Z-axis direction. An upper part of the one end portion 262 is connected to the bottom wall 261B and the partition wall 261E. A lower end surface 262A having an annular shape is formed at the lower end portion of the one end portion 62. An opening portion 262b extending in the Z-axis direction is formed in the one end portion 262. The opening portion 262b is defined by an inner peripheral surface of the one end portion 262. The opening portion 262b communicates with the first hollow portion 261c at an upper part of the opening portion 262b and communicates with the outside at a lower part of the opening portion 262b.

A substantially annular upper end surface 262E is formed on the upper part of the one end portion 262. Ventilation holes 262c are formed at a plurality of places of the one end portion 262 such that the one end portion 262 penetrates in the Z-axis direction from the upper end surface 262E to the lower end surface 262A. The ventilation holes 262c are respectively formed in a rectangular shape in an upper-lower direction view and are disposed in an annular shape along an extending direction of the upper end surface 262E or the lower end surface 262A. The ventilation hole 262c is positioned between the ball members 64 in the bottom view. The ventilation hole 262c communicates with the second hollow portion 261f at the upper end surface 262E and communicates with the outside at the lower end surface 262A.

The one end portion 262 further includes a substantially cylindrical inner wall 262F extending in the Z-axis direction. The inner wall 262F extends upward from the upper end surface 262E to the partition wall 261E and is connected to the partition wall 261E. An outer peripheral portion of the inner wall 262F defines the second hollow portion 261f. An inner peripheral portion of the inner wall 262F defines an upper part of the opening portion 262b. In other words, the inner wall 262F functions as a partition wall separating the opening portion 262b from the second hollow portion 261f.

A shape and a configuration of the lower end surface 262A are the same as those of the lower end surface 162A according to the second embodiment. A support mode and disposing of the ball member 64 and the partition member 65 are the same as those of the one end portion 162 according to the second embodiment.

The exhaust portion 267 is a hollow cylindrical member having an oval cross-sectional shape. The exhaust portion 267 is located below the air suction portion 66 and is provided so as to extend in the horizontal direction from the side wall 261A. The exhaust portion 267 includes an exhaust hole 267a inside the exhaust portion 267. The exhaust hole 267a communicates with the outside at an outer end portion of the exhaust part 267 and communicates with the communication hole 261g at a connection portion with the side wall 261A. The tube 81 can be connected to an outer end portion of the exhaust portion 267. The exhaust portion 267 is connected to the exhaust device 91 by connecting the tube 81.

During the processing operation, the cutting chip is prevented from scattering to the outside and is collected by the exhaust device 91 and the dust collection device 90 which are provided outside the nose guard 60.

Specifically, the exhaust device 91 supplies air in parallel with the processing operation and moves air into the inside of the nose guard 60 through the tube 81. As indicated by white arrows in FIG. 9C, the supplied air sequentially passes through the exhaust hole 267a, the communication hole 261g, the second hollow portion 261f, and the ventilation hole 262c, and is exhausted to the outside from the lower end surface 262A.

At the same time, the dust collection device 90 suctions air and moves air from the inside of the nose guard 60 through the tube 80. With the movement of air, as indicated by white arrows in FIG. 9B, the cutting chip sequentially passes through the opening portion 262b, the hollow portion 261c, the communication hole 261d, and the air suction hole 66a, and is finally collected to the dust collection device 90.

The exhausted air passes between the partitioning member 65 and the workpiece W, or passes through the partitioning member 65, and is suctioned from the opening portion 262b. The cutting chip moves along with a flow of air. Therefore, the cutting chip is prevented from scattering outward and is collected efficiently. In addition to the function of the partitioning member 65 described above, the flow of air prevents the cutting chip from entering between the ball member 64 and the workpiece W. Therefore, the workpiece W is prevented from being damaged.

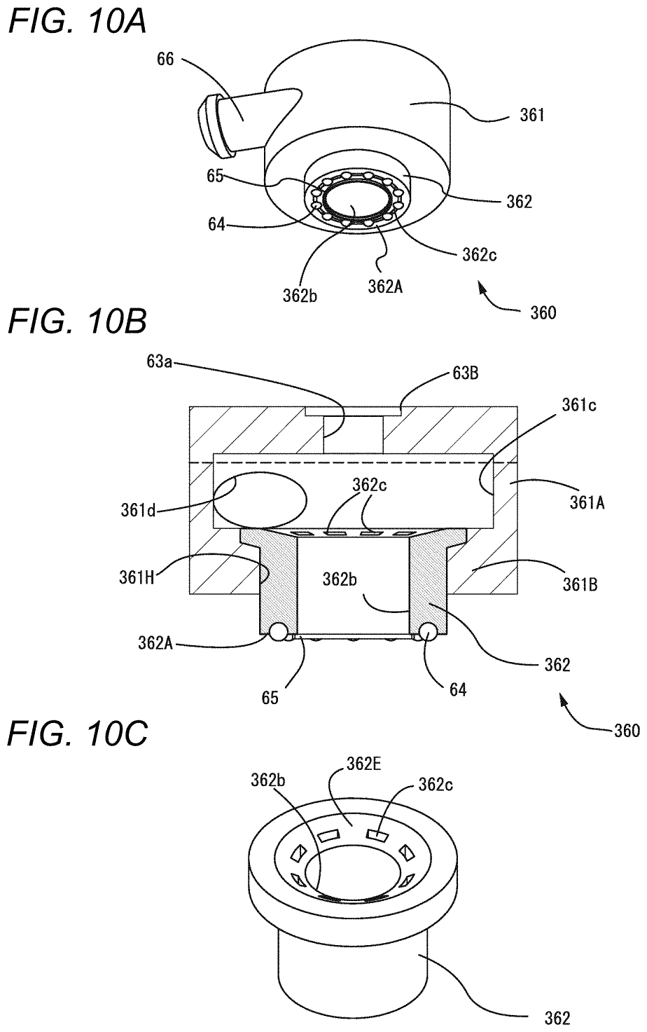

A nose guard 360 according to the fourth embodiment of the present invention will be described with reference to FIGS. 10A to 10C. The fourth embodiment will be described by adding 300 to the reference numerals of the members corresponding to the first embodiment. The same members as those in the first embodiment are denoted by the same reference numerals, and the description of the same members is omitted.

The nose guard 360 includes a main body portion 361, one end portion 362, the other end portion 63, the ball member 64, the partitioning member 65, and the air suction portion 66. The other end portion 63, the ball member 64, the partitioning member 65, and the air suction portion 66 are the same as those according to the first embodiment.

The main body portion 361 is a hollow member extending in the Z-axis direction from the other end portion 63 to the one end portion 362 and includes a side wall 361A and a bottom wall 361B. The side wall 361A is a hollow and substantially cylindrical member extending in the Z-axis direction. The side wall 361A is formed with a communication hole 361d having a substantially oval shape in the side view. The communication hole 361d communicates with the air suction portion 66 and the outside. The bottom wall 361B is a plate-shaped member formed in a substantially annular shape. An outer end portion of the bottom wall 361B is connected to a lower end portion of the side wall 361A. The bottom wall 361B extends in the substantially horizontal direction. A substantially cylindrical holding portion 361H is formed at a central part of the bottom wall 361B. The holding portion 361H is formed with an opening having the same size and the same shape as an outer peripheral portion of the one end portion 362 and can hold the one end portion 362 detachably. Alternatively, the holding portion 361H may be threaded and screwed with the one end portion 362 to hold the one end portion 362.

The main body portion 361 can be divided in the upper-lower direction as indicated by a dividing line (a dotted line) in FIG. 10B. Specifically, the main body portion 361 is formed of separate components in an upper part and a lower part and is assembled by screwing or fitting with each other.

The one end portion 362 is a hollow and substantially cylindrical member extending in the Z-axis direction and includes an opening portion 362b inside the one end portion 362. The opening portion 362b is defined by an inner peripheral surface of the one end portion 362. The opening portion 362b communicates with a hollow portion 361c at an upper part of the opening portion 362b and communicates with the outside at a lower part of the opening portion 362b. An outer peripheral surface of an upper end portion of the one end portion 362 abuts on the bottom wall 361B and is held detachably. A lower end surface 362A having an annular shape is formed at a lower end portion of the one end portion 362. An annular upper end surface 362E is formed on an upper end portion of the one end portion 362.

Ventilation holes 362c are formed at a plurality of places of the one end portion 362. Each of the ventilation holes 362c has a substantially rectangular shape in the bottom view and is formed so as to penetrate the one end portion 362 in the Z-axis direction from the lower end surface 362A to the upper end surface 262E. The ventilation holes 362c are positioned between the ball members 64 and are disposed in an annular shape in the bottom view. The ventilation hole 362c communicates with the hollow portion 361c at an upper part of the one end portion 362 and communicates with the outside at the lower end surface 362A.

A shape and a configuration of the lower end surface 362A are the same as those of the lower end surface 162A according to the second embodiment. A support mode and disposing of the ball member 64 and the partition member 65 are the same as those of the one end portion 162, 262 according to the second and third embodiments.

With the above-described configuration, the nose guard 360 functions similarly to the nose guard 160 according to the second embodiment. In the nose guard 360, the one end portion 362 can be removed or replaced when the ball member 64, the partitioning member 65, or the like is worn out or fails. Upon removal, first, the main body portion 361 is disassembled into upper and lower portions, and then the one end portion 362 is detached from the holding portion 361H. The one end portion 362 can be detached from the main body portion 361. Therefore, it is easy to repair and replace the one end portion 362 or a component attached to the one end portion 362.

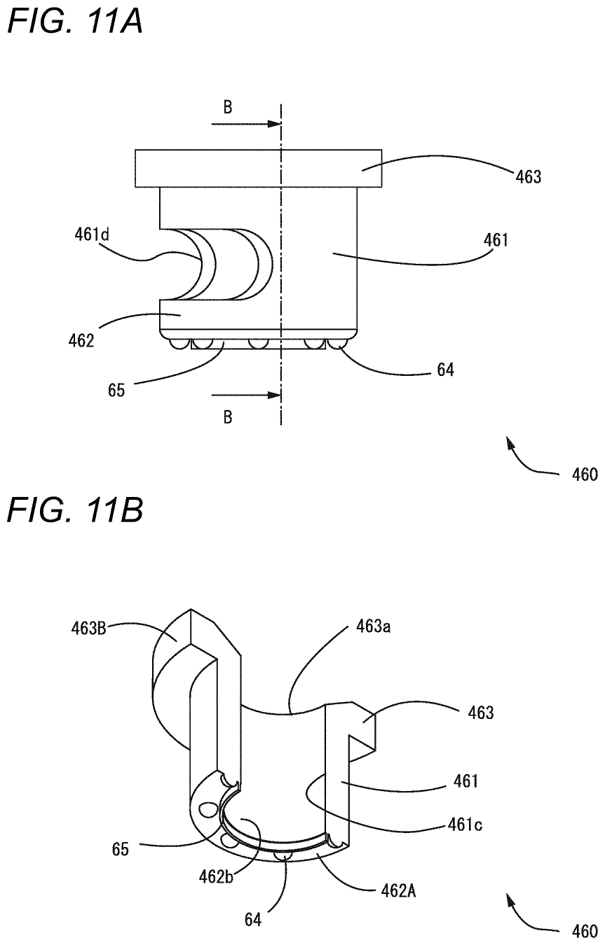

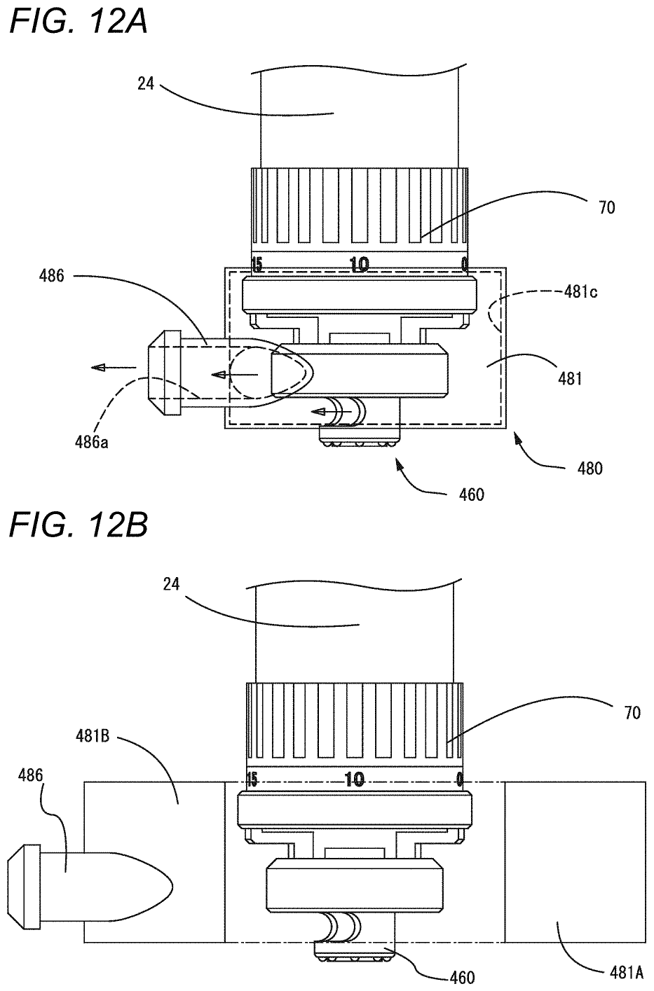

A nose guard 460 according to a fifth embodiment of the present invention will be described with reference to FIGS. 11A and 12B. The fifth embodiment will be described by adding 400 to the reference numerals of the members corresponding to the first embodiment. The same members as those in the first embodiment are denoted by the same reference numerals, and the description of the same members is omitted.

As illustrated in FIGS. 11A and 11B, the nose guard 460 includes a main body portion 461, one end portion 462, the other end portion 463, the ball member 64, and the partitioning member 65. The ball member 64 and the partitioning member 65 are the same as those according to the first embodiment.

The main body portion 461 is a hollow and substantially cylindrical member extending in the Z-axis direction from the other end portion 463 to the one end 462 and is formed with a hollow portion 461c. The main body portion 461 is formed with a communication hole 461d having a substantially oval shape in the side view. The hollow portion 461c communicates with the outside through the communication hole 461d. An upper end portion of the main body portion 461 is connected to the other end portion 463, and a lower end portion of the main body portion 461 is connected to the one end portion 462.

The one end portion 462 is a hollow and substantially cylindrical member extending in the Z-axis direction and is connected to the lower end portion of the main body portion 461. An opening portion 462b is formed inside the one end portion 462. The opening portion 462b is defined by an inner peripheral surface of the one end portion 462. The opening portion 462b communicates with the hollow portion 461c at an upper part of the opening portion 462b and communicates with the outside at a lower part of the opening portion 462b. A lower end surface 462A having a substantially annular shape is formed at a lower end portion of the one end portion 462.

A shape and a configuration of the lower end surface 462A are the same as those of the lower end surface 62A according to the first embodiment. A support mode and disposing of the ball member 64 and the partition member 65 are the same as those of the one end portion 62 according to the first embodiment.

The other end portion 463 has a substantially annular shape in the top view and is connected to the upper end portion of the main body portion 461. An opening portion 463a having a substantially circular shape in the top view is formed at a central part of the other end portion 463. The opening portion 463a is a hole for passing the tip end tool 21 in the Z-axis direction and communicates with the hollow portion 461c. An engagement portion 463B having a substantially annular shape in the top view is formed at the other end portion 463. The engagement portion 463B is engageable with the lower end portion of the guard holder 70. The nose guard 460 is detachably attached to the guard holder 70 by the engaging portion 463B engaging with the guard holder 70 (FIGS. 12A and 12B). Various methods, which are screwing, fitting, press fitting, and the like, may be used as a method of engaging or attaching the engagement portion 463B to the guard holder 70.

A dust collection adapter 480 can be further attached to the guard holder 70 such that the nose guard 460 is attached (FIGS. 12A and 12B). The dust collection adapter 480 is formed of a translucent or transparent member and includes a main body portion 481 and an air suction portion 486.

The main body portion 481 is formed in a hollow and substantially cylindrical shape and is formed with a hollow portion 481c inside the main body portion 481. At a time of attaching, an upper part of the main body portion 481 abuts on an outer peripheral surface of the guard holder 70 without a gap, and a lower part of the main body portion 481 abuts on an outer peripheral surface of the nose guard 460 without a gap.

The main body portion 481 is divided into left and right portions at a center part of the main body portion 481 and can be divided into two members which are a first member 481A and a second member 481B. At the time of attaching, as illustrated in FIG. 12A, the first member 481A and the second member 481B are engaged with each other from left and right of the guard holder 70 and the nose guard 460. Further, the main body portion 481 is fixed to the guard holder 70 by using a clamp, a screw, or the like (not illustrated).

The air suction portion 486 is a hollow cylindrical member and is provided so as to protrude in the horizontal direction from a side wall of the main body portion 481. An air suction hole 486a having a substantially oval shape in the cross-sectional view is formed inside the air suction portion 486. The air suction hole 486a communicates with the hollow portion 481c. The air suction hole 486a communicates with the outside at an outer end portion of the air suction portion 486. The tube 80 can be attached to the outer end portion of the air suction portion 486. Therefore, the air suction portion 486 can be connected to the dust collection device 90 through the tube 80.

During the processing operation, it is also possible to attach only the nose guard 460 to the guard holder 70 without using the dust collection adapter 480. The nose guard 460 is brought into contact with the workpiece W to adjust the upper-lower position of the tip end tool 21 with respect to the workpiece W to cause the engraving depth to be appropriate. At this time, the ball member 64 rolls while being in contact with the workpiece W and follows the scanning of the tip end tool 21. The ball member 64 does not slide but rolls relative to the workpiece W. Therefore, the workpiece W is prevented from being scratched. The tip end tool 21 and the processing site can be recognized visually through the communication hole 461d during the processing operation. Therefore, workability can be improved.

When the dust collection adapter 480 is attached and the processing operation is performed, the dust is collected by the dust collection device 90. Specifically, the dust collection device 90 suctions air in parallel with the processing operation and moves air from inside of the nose guard 460 through the communication hole 461d through the tube 80. With the movement of air, the cutting chip sequentially passes through the opening portion 462b, the hollow portion 461c, and the communication hole 461d. As indicated by white arrows in FIG. 12A, the cutting chip is finally collected to the dust collection device 90 through the air suction hole 486a. The dust collection adapter 480 is translucent or transparent. Therefore, even in a state where the dust collection adapter 480 is attached, as described above, the processing site can be visually recognized through the communication hole 461d so that the workability can be improved.

A part of the cutting chip is to be scattered radially outward of the tip end tool 21 as the tip end tool 21 rotates. At this time, the partitioning member 65 partitions a periphery of the opening portion 462b, thereby preventing the cutting chip from being scattered outward. Accordingly, the cutting chip is collected efficiently. The partition member 65 also prevents the cutting chip from entering between the ball member 64 and the workpiece W. Therefore, the workpiece W is prevented from being damaged.

In the above embodiments, the nose guard 60, 160, 260, 360, 460 is attached to the tip end tool holding portion 24 via the guard holder 70. However, the present invention is not limited to this configuration. The nose guard 60, 160, 260, 360, 460 may be attached directly to the tip end tool holding portion 24.

The nose guards 60, 160, 260, 360, 460 may be formed at least in part by a transparent or translucent material. The tip end tool 21 and the processing site can be recognized visually by providing a portion through which light can be transmitted. Therefore, the workability can be improved.

The shape of the one end face 62A, 162A, 262A, 362A, 462A is not limited to an annular shape and can be any shape.

In each of the above-described embodiments and modifications, a nose guard (60, 160, 260, 360, 460) includes one end portion (62, 162, 262, 362, 462) having an opening portion (62b, 162b, 262b, 362b, 462b) and the other end portion (63, 463) configured to be detachably attached to from a tip end tool holding portion (24). The nose guard includes a main body portion (61, 261, 361, 461) extending in a Z-axis direction from the other end portion to the one end portion and has a hollow portion (61c, 261c, 361c, 461c) communicating with the opening portion. The nose guard further includes a ball member (64) rollably supported by the one end portion and protruding in the Z-axis direction from a lower end surface (62A, 162A, 262A, 362A, 462A) of the one end portion.

In the above configuration, the ball member does not slide but rolls relative to a workpiece. Therefore, the workpiece is prevented from being scratched. A tip end tool and a processing site can be recognized visually through a communication hole at a time of processing operation. Therefore, workability can be improved. It is possible to suction air and collect cutting chip from a periphery of the tip end tool through the opening portion. Therefore, the cutting chip is collected efficiently.

The main body portion is further formed with a communication hole (61d, 261d, 361d, 461d) which communicates the hollow portion to outside.

In the above configuration, it is possible to suction air to collect the cutting chip from a periphery of the tip end tool through the opening portion and the communication hole. Therefore, the cutting chip is collected efficiently.

The nose guard further includes a partition member (65) which is supported by the one end portion, extends in the Z-axis direction, and is disposed along an inner peripheral direction of the one end portion.

In the above configuration, the partition member prevents the cutting chip from scattering outward. Accordingly, the cutting chip is collected efficiently. The cutting chip is prevented from entering between the ball member and the workpiece. Therefore, the workpiece is prevented from being damaged.

At least a part of the main body portion, the one end portion, and the other end portion (for example, at least one of the main body portion, the one end portion, and the other end portion) is transparent or translucent.

In the above configuration, the processing site and the tip end tool can be recognized visually through the main body portion, the one end portion, and the other end portion. Therefore, visual inspection of an operation condition is possible. Therefore, the workability is improved.

A lower end surface of the one end portion is formed in an annular shape. Therefore, the end face and the ball member can be disposed equidistantly from the tip end tool, and movement of the tip end tool holding portion and the tip end tool is easy regardless of a direction of scanning. The cutting chip can be collected efficiently in any direction.

The one end portion (162, 262, 362) is further formed with a ventilation hole (162c, 262c, 362c) which extends in the Z-axis direction from the lower end surface (162A, 262A, 362A) and which communicates the outside with the hollow portion (61c, 261f, 361c).

In the above configuration, ventilation is possible also from the lower end surface. Therefore, dust collection efficiency can be improved.

The main body portion (261) includes a partition wall (261E) which is configured to partition the hollow portion into a first hollow portion (261c) communicating with the communication hole (261d) and the opening portion (262b) and a second hollow portion (2610. The one end portion (262) is further formed with a ventilation hole (262c) which extends in the Z-axis direction from the lower end surface (262A) and which communicates the outside with the second hollow portion (2610.

In the above configuration, it is possible to suction air from the opening portion and the first hollow portion and exhaust air from the ventilation hole and the second hollow portion. Therefore, the dust collection efficiency can be improved.

The ventilation hole (162c, 262c, 362c) is positioned between the ball members (64) in an upper-lower direction view.

The ventilation hole is disposed between the ball members. Therefore, compact disposing is possible and the nose guard can be miniaturized. The cutting chip is prevented from entering between the ball member and the workpiece so that the workpiece is prevented from being damaged.

The one end portion (362) is detachably attached to the main body portion (361). In this configuration, it is easy to repair and replace the one end portion (362) or a component attached to the one end portion (362).

The engraving machine (1) includes a motor (20), a tip end tool (21) which is configured to be rotationally driven by the motor, and a tip end tool holding portion (24) which rotatably holds the tip end tool. The engraving machine (1) further includes a nose guard (60, 160, 260, 360, 460).

A nose guard includes one end portion (62, 162, 262, 362, 462) which is formed with an opening portion (62b, 162b, 262b, 362b, 462b) and the other end portion (63, 463) which is configured to be attached to and detached from a tip end tool holding portion (24). The nose guard includes a main body portion (61, 261, 361, 461) which extends in a Z-axis direction from the other end portion to the one end portion and is formed with a hollow portion (61c, 261c, 361c, 461c) communicating with the opening portion, and a ball member (64) which is rollably supported by the one end portion and protrudes from a lower end surface of the one end portion.

In the above configuration, the ball member does not slide but rolls relative to the workpiece. Therefore, the workpiece is prevented from being damaged.

What is claimed is:

1. A protective device for a processing machine, the protective device comprising:
one end portion including an opening portion;
another end portion configured to be detachably attached to and detached from a tip end tool holding portion of the processing machine;
a main body portion extending in a predetermined direction from the other end portion to the one end portion, the main body portion including a hollow portion communicating with the opening portion; and
a spherical member rollably supported by the one end portion, the spherical member protruding in the predetermined direction from an end surface of the one end portion.

2. The protective device according to claim 1,
wherein the main body portion includes a communication hole through which the hollow portion communicates with an outside of the main body portion.

3. The protective device according to claim 1, further comprising a partition member supported by the one end portion, the partition member extending in the predetermined direction and being disposed along an inner peripheral direction of the one end portion.

4. The protective device according to claim 1,
wherein at least a part of the main body portion, the one end portion, and the other end portion is transparent or translucent.

5. The protective device according to claim 1,
wherein the end surface has an annular shape.

6. The protective device according to claim 1,
wherein the one end portion includes a ventilation hole extending along the predetermined direction from the end surface and through which the hollow portion communicates with an outside of the protective device.

7. The protective device according to claim 2
wherein the main body portion includes a partition wall partitioning the hollow portion into a first hollow portion and a second hollow portion,
wherein the first hollow portion communicates with the communication hole and the opening portion, and
wherein the one end portion includes a ventilation hole extending along the predetermined direction from the end surface and through which the second hollow portion communicates with the outside.

8. The protective device according to claim 6, further comprising a plurality of the spherical members,
wherein the ventilation hole is provided between the spherical members when viewed along the predetermined direction.

9. The protective device according to claim 1,
wherein the one end portion is detachably attached to the main body portion.

10. A processing machine comprising:
a motor;
a tip end tool configured to be rotated by the motor;
a holding portion configured to rotatably hold the tip end tool; and
a protective device,
wherein the protective device includes one end portion, another end portion, a main body portion, and a spherical member,
wherein the one end portion includes an opening portion,
wherein the other end portion is configured to be detachably attached to the holding portion,
wherein the main body portion extends in a predetermined direction from the other end portion to the one end portion and includes a hollow portion communicating with the opening portion, and
wherein the spherical member is rollably supported by the one end portion and protrudes in the predetermined direction from an end surface of the one end portion.
